(19) United States
(12) Patent Application Publication
(10) Pub. No.: US 2014/0108198 A1
(43) Pub. Date: Apr. 17, 2014

(54) Reputation System Based on Driving Behavior

(71) Applicant: Automatic Labs, Inc., San Francisco, CA (US)

(72) Inventors: Jerald Jariyasunant, San Francisco, CA (US); Thejovardhana S. Kote, San Francisco, CA (US)

(73) Assignee: Automatic Labs, Inc., San Francisco, CA (US)

(21) Appl. No.: 14/050,602

(22) Filed: Oct. 10, 2013

Related U.S. Application Data
(60) Provisional application No. 61/712,442, filed on Oct. 11, 2012.

(51) Int. Cl. G06Q 30/06

(52) U.S. Cl. CPC G06Q 30/0609
USPC 705/26.35

(57) ABSTRACT

A system has an Internet-connected server having a processor and data storage coupled to the server, and software executing on the processor from a non-transitory physical medium. The software provides functions for collecting driver behavior raw data based on actual driving performance for a plurality of drivers, calculating by pre-programmed algorithm and storing a driver performance score for individual ones of the plurality of drivers, and making performance scores for individual ones of the drivers available to one or both of drivers for whom the performance scores are prepared and to requesting enterprises.

### CROSS-REFERENCE TO RELATED APPLICATIONS

The present application claims priority to Provisional Patent Application (PPA) Ser. No. 61/712,442, filed on Oct. 11, 2012. All disclosure in the referenced PPA is incorporated at least by reference.

### BACKGROUND OF THE INVENTION

1. Field of the Invention

The present invention is in the technical area of computer-implemented inventions, and pertains more particularly to monitoring driver behavior in vehicles on public roadways, and creating behavior models and driver-performance scores for particular drivers based on their driving behavior.

2. Description of Related Art

Trust dynamics are used in the computer arts in a number of ways to enhance security in communication, and in qualifying people, for example, for loans. Trust dynamics are also used by enterprises offering sales platforms for sellers, so buyers have a reputation to access for sellers. No such dynamic presently exists in commerce related to automobiles and trucks. What is need is a system for establishing reliable reputation or performance scores based on driving behavior. Such scores could have use by rental car companies for example, to set variable rates based on such reputation, by insurance companies, to manage premium charges for insurance, and the like.

### BRIEF SUMMARY OF THE INVENTION

In an embodiment of the invention a system is provided, comprising an Internet-connected server having a processor and data storage coupled to the server, and software executing on the processor from a non-transitory physical medium. The software provides functions for collecting driver behavior raw data based on actual driving performance for a plurality of drivers, calculating by pre-programmed algorithm and storing a driver performance score for individual ones of the plurality of drivers, and making performance scores for individual ones of the drivers available to one or both of drivers for whom the performance scores are prepared and to requesting enterprises.

In one embodiment, in addition to performance scores, events used in determining performance scores are made available to the requesting enterprises. Also in one embodiment raw data related to driver behavior for a driver of a specific vehicle is collected by monitoring sensors provided by a manufacturer in a vehicle, sensors accessible through the vehicle's On Board Diagnostics (OBD) port, sensors in a Link device, or sensors in a mobile communication device associated with the driver, and the raw data is sent to the Server for processing along with the driver's and the vehicle's identity.

In another embodiment specific driving events, including at least rapid acceleration events, rapid deceleration events and speeding events, are determined by an application executing on the mobile communication device, and subsequently provided to the server by Internet link, and the server uses the events in determining a performance score for the driver. Also in another embodiment raw data collected is sent to the server by the mobile communication device, and events are determined by algorithm at the server, and the server uses the events in determining a performance score for the driver.

In yet another embodiment graphics are prepared and stored based on driving sessions monitored by the system, the graphics illustrating time and location for start and end of trip, and time and location of events determined during the driving sessions. In still another embodiment the graphics are interactive, with at least links for displaying locations on a map. In another embodiment the graphics are made available to one or both of the drivers associated with the driving sessions and to requesting enterprises.

In another aspect of the invention a method is provided, comprising steps for collecting driver behavior raw data based on actual driving performance for a plurality of drivers and providing the data to an Internet-connected server having a processor and data storage coupled to the server, calculating by the server, using software executing from a non-transitory medium, from the raw data by pre-programmed algorithm and storing a driver performance score for individual ones of the plurality of drivers, and making performance scores for individual ones of the drivers available to one or both of drivers for whom the performance scores are prepared and to requesting enterprises.

In one embodiment of the method, in addition to performance scores, events used in determining performance scores are made available to the requesting enterprises. Also in one embodiment raw data related to driver behavior for a driver of a specific vehicle is collected by monitoring sensors in one or more of a vehicle's OBD computerized system, raw data collected by a Link device connected to the vehicle's OBD Port, in the Link device, or in a mobile communication device associated with the driver, and the raw data is sent to the Server for processing along with the driver's and the vehicle's identity.

In another embodiment of the method specific driving events, including at least rapid acceleration events, rapid deceleration events and speeding events, are determined by an application executing on the mobile communication device, and subsequently provided to the server by Internet link, and the server uses the events in determining a performance score for the driver. In another embodiment raw data collected is sent to the server by the mobile communication device, and events are determined by algorithm at the server, and the server uses the events in determining a performance score for the driver. In yet another embodiment graphics are prepared and stored based on driving sessions monitored by the system, the graphics illustrating time and location for start and end of trip, and time and location of events determined during the driving sessions.

In yet another embodiment of the method the graphics are interactive, with at least links for displaying locations on a map. In one more embodiment the graphics are made available to one or both of the drivers associated with the driving sessions and to requesting enterprises.

### BRIEF DESCRIPTION OF THE SEVERAL VIEWS OF THE DRAWINGS

FIG. 1 is diagram illustrating elements and connection in an embodiment of the present invention.

FIG. 2 is an architecture diagram illustrating elements and network connectivity in an embodiment of the invention.

FIG. 3 is a diagram representing a driving session during which data was collected and events determined in an embodiment of the invention.

FIGS. 4a and 4b are a diagrams illustrating operation of an Internet-connected server in making driver performance scores available to the general public and to other enterprises in en embodiment of the invention.

### DETAILED DESCRIPTION OF THE INVENTION

Reputation systems are an important component used to establish trust in marketplaces. The reputation system used by eBay is a good example that increases confidence among different players in a marketplace. The automotive industry is extremely large, but no such reputation system exists which can make transactions more efficient. The way someone drives an automobile is a valuable source of reputation data. Driving behavior data may have a direct or indirect influence on reputation depending on the situation. For example, if a rental car company wants to set prices based on how safely someone drives, driving behavior data can have a direct influence on the decision-making process. Automobile insurance companies have shown that credit scores are correlated to driving behavior. In the same way, driving behavior might be correlated to financial responsibility and behavior. This would be an example of an indirect use of driving behavior data for reputation determination.

The present invention allows determination of a driver performance score for a user based on his or her driving behavior data. This score may then be used in multiple situations that include, but are not limited to, peer-t-peer car rentals, traditional car rentals, ride sharing etc. The score itself is calculated using weighted models which use components of driving behavior data that include, but are not limited to, acceleration and braking data, speed, time of day the car is driven, RPM of the vehicle etc.

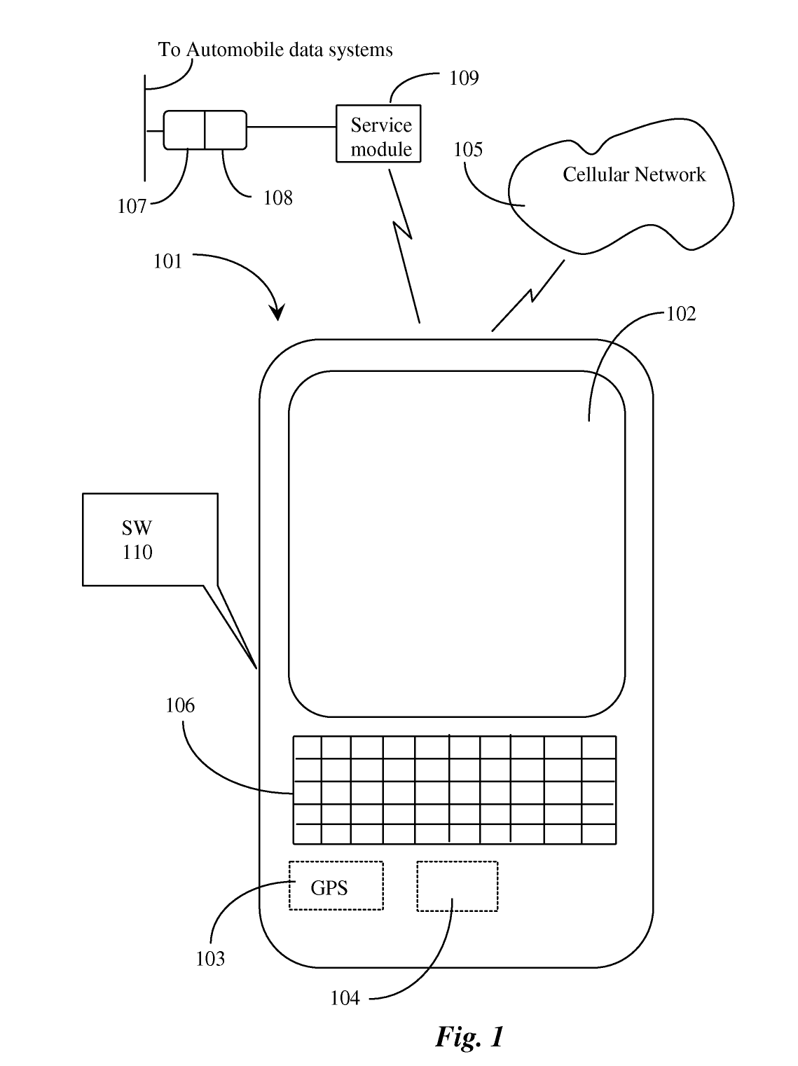

FIG. 1 illustrates a computerized communication device 101, such as a cellular smart telephone having a display screen 102, which may be a touch screen. Device 101 is shown paired by near-field communication pairing with a Link device 109, connected by an OBD connector 108 to an OBD connector 107 of a vehicle. Device 101 is also coupled wirelessly to a cellular network 105 in this example. Device 101 is thus enabled to access data from on-board computerized devices in the vehicle through a CAN bus in the vehicle, and to transmit this data to and through cellular network 105. In some embodiments of the present invention device 101 may execute an application 110, shown as software (SW) 110 in FIG. 1. SW 110 is described in enabling detail below.

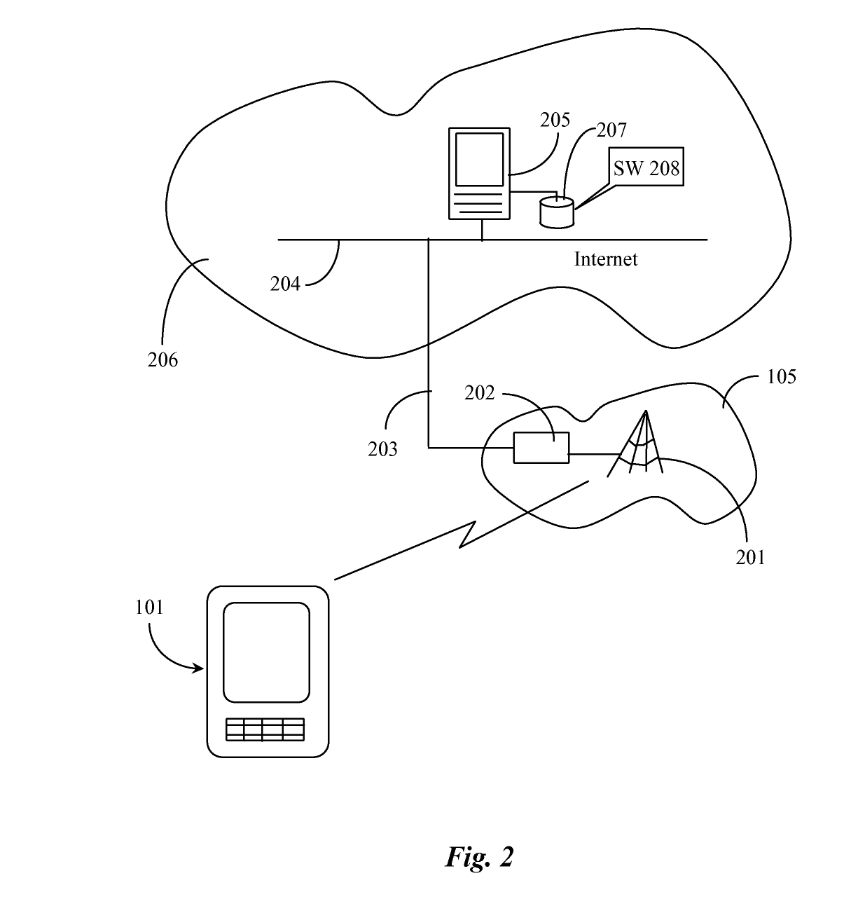

FIG. 2 is an architectural diagram representing device 101 connected through cellular network 105 by a base station and through a gateway 202 and path 203 to Internet backbone 204. Backbone 204 represents all of the connections and interconnections in the Internet network. An Internet connected server 205, hosted by an enterprise not shown, is coupled to a database 207, which includes a non-transitory digital medium from which Server 208 may execute software 208.

It might be questioned why a driver of a vehicle might agree to monitoring of his or her driving behavior, or creation of a performance score based on that behavior. One good reason might be that the driver believes himself or herself to be a good driver, and may also be aware that a good performance score based on driving behavior could result in lowered insurance premiums, lowered cost for rental cars, and other financial benefit. In the case of drivers who are aware that they are not good drivers, some may be required by court order, for example, to equip their automobiles to practice an embodiment of this invention as a way of motivating such drivers to improve their driving behavior. Other poor drivers, who may be intent on correcting their behavior, and may recognize that attaining a good performance score will improve their financial position, may also be willing to participate.

In various embodiments of the present invention, for a driver who is amenable to being monitored to develop a performance score, an application may be downloaded from server 205 hosted by an enterprise that provides services in monitoring drivers and determining performance scores. The app is loaded to device 101 to execute, and is represented in FIG. 1 by SW 110. SW 110 in certain execution sessions monitors GPS location in some embodiments using a GPS system of device 101. In some other embodiments the vehicle to which OBD connector 107 belongs may have a GPS system, and device 101 may monitor and store GPS data during a defined session by pulling GPS data from the vehicle GPS system by Link 109 and transmission to device 101 via near-field wireless pairing as shown in FIG. 1. During an active collection session in one embodiment data may be pulled from vehicle on-board devices and also developed by monitoring sensors in device 101, such as a GPS system or an accelerometer if present. In another embodiment Link device 109 may not be present and all data may be developed by device 101 executing SW 110.

In some embodiments of the invention SW 110 may be an Application (App) especially programmed to be compatible and interactive with Link device 109 and with SW 208 executing on Server 205 hosted by an Enterprise that provides Link devices and Apps for a number of different uses. In these embodiments each Link device and App may have a unique ID, and communication may be secured by a secret Key, requiring Key signature for communication between the user's mobile device 101 and Link 109. Such a system is taught and claimed in a separate patent application.

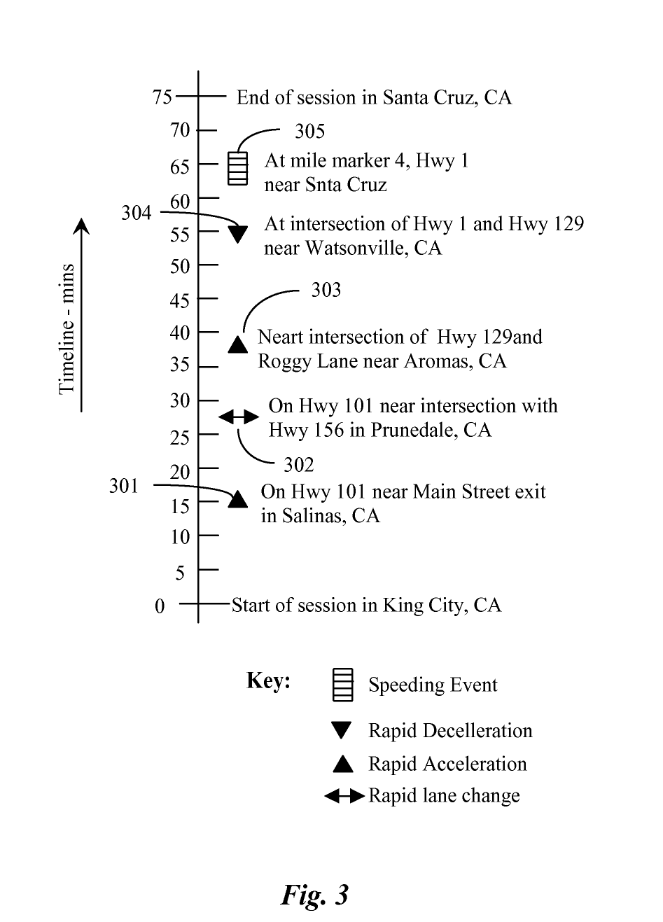

FIG. 3 is a diagram representing a driving session during which data collection has been done, and events have been determined from the data by algorithm execution. The session represented in FIG. 3 indicates a trip was started in King City, Calif., which proceeded uneventfully until 15 minutes into the trip, at which point a rapid acceleration even was recorded. The rapid acceleration event is a result of changing vehicle speed over a time interval that is determined to qualify as an event based on a preprogrammed threshold that is set by management of an enterprise hosting web server 205, and is indicated in FIG. 3 by a triangular icon 302 with apex facing upward. In most embodiments such an event may figure negatively into a performance score calculated and maintained for the driver of the vehicle. The rapid acceleration event is determined by GPS with association with data provided by Server 205 to have occurred on Highway 101 near Main Street exit in Salinas, Calif., and the location is indicated near icon 301 in the diagram of FIG. 3.

At about twenty-seven minutes into this trip an event is indicated that sudden swerving or lane changes took place. Again, the determination is made by monitoring vehicle velocity and location data and comparing by algorithm to a pre-programmed definition of what may constitute such an event. Icon 302 for the lane changes is a horizontal, double-ended arrow. The lane change event is determined to have occurred on Highway 101 near the intersection with Highway 156 in Prunedale, Calif., and the location is indicated near icon 302 in the diagram of FIG. 3.

At about thirty-eight minutes into the trip another rapid acceleration event is determined to have occurred, and is indicated at this point by an Icon 303, with location determined and provided. At fifty-five minutes a rapid deceleration, indicating extreme braking, is indicated, determined again by monitoring vehicle speed against time, and comparing to pre-programmed definition by algorithm. Icon 304 for the deceleration event is like the acceleration icon, but reversed vertically, pointing downward. The second rapid acceleration event is determined to have occurred on Highway 129 near the intersection with Rogge Road near Aromas, Calif., and the location is indicated near icon 304 in the diagram of FIG. 3.

At sixty-five minutes a speeding event is determined to have occurred, and is indicated by a special icon 305 as shown. The system of the invention, managed by Server 305, has stored and accessible data, including speed limits on highways and major roads, which is compared to location and speed of the monitored vehicle, to determine a speeding event. The speeding event took place at mile marker 4 on Highway 1 near Santa Cruz, Calif.

The defined trip is indicated as completed at seventy-five minutes in Santa Cruz, Calif.

Data for a particular driver may be monitored and stored over a series of several trips taken over a defined time period, such as 30 days before any performance score is calculated and stored for that driver. When a performance score is determined, monitoring of the same driver's behavior may continue over a series of trips over a subsequent time period, and the performance score may be amended by improved or degraded behavior.

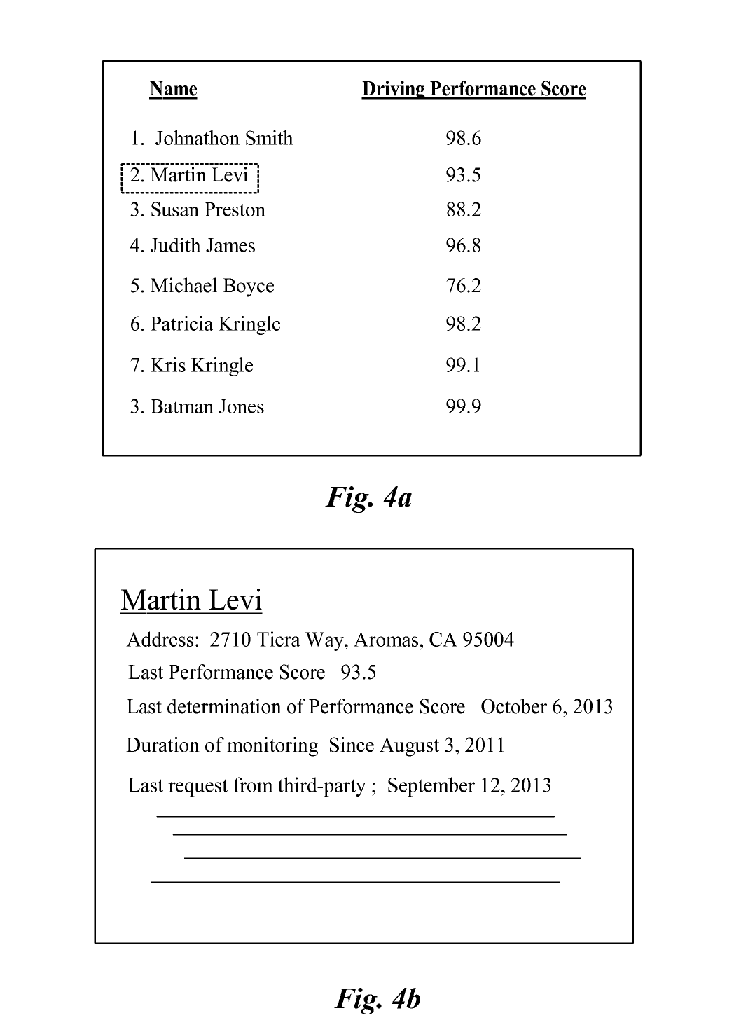

FIG. 4a is a diagram illustrating data stored on dB 207 by Server 205 for a several persons for whom driving behavior has been, or is being monitored. Names of the persons are listed and a Driving Performance Score is listed for each person. In this embodiment a profile is kept for each person for whom Performance scores are calculated, and each name in FIG. 4a is a link to that person's profile.

FIG. 4b is a profile for Martin Levi, illustrating address, last performance score, date of last determination of a score, duration of monitoring for Martin Levi, and date of last request for a performance score for Martin Levi. The skilled person will realize that the nature of data stored and accessible for each person in the system may vary considerably from the example given.

In various embodiments of the invention, performance scores and actual performance of persons who have agreed to monitoring may be made available to third-party enterprises. Among these enterprises may be rental car companies, vehicle insurance companies, credit card companies, banks and lending institutions and many more. Privy concerns are paramount in this sharing, and persons for whom performance scores are calculated and kept may be informed each time an enterprise requests a performance rating or background data used in determining ratings. The information made available may be managed and presented in a variety of ways, including charts as illustrated in FIG. 3. In some embodiments of the invention the persons for whom Performance scores are determined may also request scores and background information, including how and when the scores were determined, background information, and charts as shown in FIG. 3.

It will be apparent to the skilled person that there are many variations that may be made in embodiments and examples described above, without affecting the scope of the invention. The scope of the invention is limited only by the claims that follow.

1. A system comprising:
an Internet-connected server having a processor and data storage coupled to the server; and
software executing on the processor from a non-transitory physical medium;
wherein the software provides functions:
collecting driver behavior raw data based on actual driving performance for a plurality of drivers;
calculating by pre-programmed algorithm and storing a driver performance score for individual ones of the plurality of drivers; and
making performance scores for individual ones of the drivers available to one or both of drivers for whom the performance scores are prepared and to requesting enterprises.

2. The system of claim 1 wherein, in addition to performance scores, events used in determining performance scores are made available to the requesting enterprises.

3. The system of claim 1 wherein raw data related to driver behavior for a driver of a specific vehicle is collected by monitoring sensors provided by a manufacturer in a vehicle, sensors accessible through the vehicle's On Board Diagnostics (OBD) port, sensors in a Link device, or sensors in a mobile communication device associated with the driver, and the raw data is sent to the Server for processing along with the driver's and the vehicle's identity.

4. The system of claim 3 wherein specific driving events, including at least rapid acceleration events, rapid deceleration events and speeding events, are determined by an application executing on the mobile communication device, and subsequently provided to the server by Internet link, and the server uses the events in determining a performance score for the driver.

5. The system of claim 4 wherein raw data collected is sent to the server by the mobile communication device, and events are determined by algorithm at the server, and the server uses the events in determining a performance score for the driver.

6. The system of claim 4 wherein graphics are prepared and stored based on driving sessions monitored by the system, the graphics illustrating time and location for start and end of trip, and time and location of events determined during the driving sessions.

7. The system of claim 6 wherein the graphics are interactive, with at least links for displaying locations on a map.

8. The system of claim 6 wherein the graphics are made available to one or both of the drivers associated with the driving sessions and to requesting enterprises.

9. A method comprising steps:
collecting driver behavior raw data based on actual driving performance for a plurality of drivers and providing the data to an Internet-connected server having a processor and data storage coupled to the server;
calculating by the server, using software executing from a non-transitory medium, from the raw data by pre-programmed algorithm and storing a driver performance score for individual ones of the plurality of drivers;
making performance scores for individual ones of the drivers available to one or both of drivers for whom the performance scores are prepared and to requesting enterprises.

10. The method of claim 9 wherein, in addition to performance scores, events used in determining performance scores are made available to the requesting enterprises.

11. The method of claim 9 wherein raw data related to driver behavior for a driver of a specific vehicle is collected by monitoring sensors in one or more of a vehicle's On Board Diagnostics (OBD) computerized system, raw data collected by a Link device connected to the vehicle's On Board Diagnostics (OBD) Port, in the Link device, or in a mobile communication device associated with the driver, and the raw data is sent to the Server for processing along with the driver's and the vehicle's identity.

12. The method of claim 11 wherein specific driving events, including at least rapid acceleration events, rapid deceleration events and speeding events, are determined by an application executing on the mobile communication device, and subsequently provided to the server by Internet link, and the server uses the events in determining a performance score for the driver.

13. The method of claim 12 wherein raw data collected is sent to the server by the mobile communication device, and events are determined by algorithm at the server, and the server uses the events in determining a performance score for the driver.

14. The method of claim 12 wherein graphics are prepared and stored based on driving sessions monitored by the system, the graphics illustrating time and location for start and end of trip, and time and location of events determined during the driving sessions.

15. The method of claim 14 wherein the graphics are interactive, with at least links for displaying locations on a map.

16. The method of claim 14 wherein the graphics are made available to one or both of the drivers associated with the driving sessions and to requesting enterprises.
